(19) United States
(12) Patent Application Publication
(10) Pub. No.: US 2008/0003166 A1
(43) Pub. Date: Jan. 3, 2008

(54) Methods of forming nanoporous carbon material and electrodes and electrochemical double layer capacitors therefrom

(76) Inventors: Yurii Maletin, Kiev (UA); Peter Novak, Ft. Lauderdale, FL (US); Elena Shembel, Coral Springs, FL (US); Vladimir Izotov, Kiev (UA); Antonina Myronova, Kiev (UA); Natalie Stryzhakova, Kiev (UA); Valeriy Danylin, Kiev (UA); Sergiy Podmogilny, Kiev (UA); Sergiy Kozachkov, Kiev (UA)

Correspondence Address: AKERMAN SENTERFITT, P.O. BOX 3188, WEST PALM BEACH, FL, 33402-3188, US

(21) Appl. No.: 11/182,507

(22) Filed: Jul. 15, 2005

Related U.S. Application Data
(60) Provisional application No. 60/616,380, filed on Oct. 6, 2004.
(60) Provisional application No. 60/588,157, filed on Jul. 15, 2004.

(51) Int. Cl. C01B 31/02; H01G 9/00

(52) U.S. Cl. 423/445 R; 29/25.03

(57) ABSTRACT

A method of forming nanoporous carbon material includes the steps of providing a natural carbonaceous material, the carbonaceous material having pores being filled with at least one other material, and treating the carbonaceous material with a strong acid or a strong base, wherein the other material is removed from the pores to form a nanoporous carbon material having open pores available for organic electrolyte. The nanoporous carbon material can be used to form composite electrodes by impregnating the open pores with an organic electrolyte. Such electrodes can be used to form electrochemical double layer capacitors (EDLC), such as by disposing an electrically insulating layer comprising a plurality of nano-size dielectric particles together with a binder directly onto a surface of at least one of anode and the cathode, and interposing the electrically insulating layer between the anode and the cathode. EDLCs formed using the invention are low cost and provide large specific energy stored and low inner resistance resulting in high power output.

### CROSS-REFERENCE TO RELATED APPLICATIONS

The Application claims the benefit of and incorporates by reference in its entirety U.S. Provisional Application No. 60/616,380 entitled “ELECTROCHEMICAL DOUBLE LAYER CAPACITOR AND METHOD,” filed on Jul. 15, 2004.

### STATEMENT REGARDING FEDERALLY SPONSORED RESEARCH OR DEVELOPMENT

Not applicable.

### FIELD OF THE INVENTION

This invention relates to processes for forming nanoporous carbon material (NCM) and electrodes therefrom from natural carbonaceous precursor materials, including bituminous coal and/or bone flour. The invention also includes high performance electrochemical double-layer capacitors (EDLCs) comprising two composite electrodes including NCM interposed by a porous electrically insulating film (separator).

### BACKGROUND OF THE INVENTION

An electrochemical double-layer capacitor (EDLC) is a relatively new type of energy storage devices based on charge separation in the double electric layer that forms at the porous electrode/liquid electrolyte interface. EDLCs embody the principle of capacitance. By their construction they are similar to electrolytic capacitors, having two electrically conductive solid electrodes put into a liquid electrolyte and interposed with an insulating porous film (a separator). The double electric layer forms at the electrode/electrolyte interface on charge, and this layer discharges during operation.

As with a conventional capacitor, the capacitance of an EDLC increases with increasing effective electrode area and decreases with increasing distance between separated charges. Various electrically conductive materials, including those based on highly porous carbon fibre or powder having a specific surface area of the order of 10³m²/g, are often used as the electrodes in an EDLC. Being coupled with the extremely low double layer thickness (<1 nm) this results in a super-large specific capacitance of EDLC devices of up to 10 F/cc, or even more.

There are known methods for obtaining microporous or nanoporous carbon powder for use in energy storage devices. These methods generally rely on synthetic carbon materials, tend to be expensive, and often require lengthy and potentially dangerous processing steps.

### SUMMARY OF THE INVENTION

The inventors have discovered that natural carbonaceous material, such as bituminous-based activated carbon, following appropriate pore development processing described herein, provides very low electrical resistance. As a result, natural carbonaceous precursor materials provide very high power density for devices formed therefrom. It is believed that the low resistance is due to a special pore shape developed in those natural carbons. Layers made from conventional synthetic carbon precursor materials can be used to provide large capacitance devices, but much higher resistance, and as a result, lower power density as compared to layers and associated devices formed using nanoporous carbon materials, such as bituminous coals according to the invention. In the series of carbonaceous materials that ranges from peat to anthracite, bituminous coal is of middle rank, containing intermediate amounts of fixed carbon, volatile material, and moisture in comparison with the other materials to which it is related.

A method of forming nanoporous carbon material (powder) comprises the steps of providing a natural carbonaceous material, the carbonaceous material having pores filled with at least one other material, and treating the carbonaceous material with a strong acid or a strong base, either in aqueous solution or melted, wherein the other material is removed from the pores to form a nanoporous carbon material having open pores. As defined herein, “open pores” refers to pores available for electrolyte penetration independent of the pore shape or length. Such pores are open for the electrolyte to enter, as opposed to closed pores, such as pores in some carbon nanotubes, where electrolyte cannot enter such a pore. The carbonaceous material preferably comprises bituminous-based activated carbon.

An average pore size of the open pores using the bituminous-based activated carbon/strong base embodiment is generally from 0.6 to 3 nm. The carbonaceous material can comprise bone flour or bone char, the strong acid in aqueous solution being used during the treating step. The average pore size of the open pores using this embodiment is generally from 5 to 12 nm.

The nanoporous carbon powder according to the invention can be used to form composite electrodes by impregnating the open pores with an organic electrolyte. In one embodiment, a size distribution of the open pores includes a primary distribution and a secondary distribution, such as a primary distribution centered at about 0.6 to 3 nm and a secondary distribution centered at about 5 to 12 nm. The secondary distribution can have an amplitude of at least 20% of an amplitude of the primary distribution. The method can include the step of kneading the nanoporous carbon material with a polymer binder suspension in a solvent to form a binder comprising nanocomposite, and then drying and rolling the binder comprising nanocomposite. An electrically conductive carbon powder can also be included in the kneading step.

A method of forming an electrochemical double layer capacitor (EDLC) comprises the steps of forming a positive or negative composite electrode (also named below as anode or cathode, correspondingly), the forming step comprising:

providing a natural carbonaceous material, the carbonaceous material having pores filled with at least one other material;

treating the carbonaceous material with a strong acid or a strong base, wherein the other material is removed from the pores to form a nanoporous carbon material having open pores,
impregnating the open pores with an organic electrolyte to form composite electrodes,
disposing an electrically insulating layer comprising a plurality of nano-size dielectric particles together with a binder comprising slurry directly a surface of at least one of the composite electrodes, and
interposing the electrically insulating layer between the anode and the cathode.

The disposing step can comprise rolling. The impregnating step can follow the interposing step, wherein the impregnating step impregnates the electrically insulating layer in addition to the anode and cathode with the organic electrolyte. The anode and cathode can include a gel-forming agent. In a preferred embodiment, an average pore size of the cathode is larger than an average pore size of the anode. EDLCs formed using the invention are low cost and provide large specific energy stored and low inner resistance resulting in high power output.

### BRIEF DESCRIPTION OF THE FIGURES

A fuller understanding of the present invention and the features and benefits thereof will be accomplished upon review of the following detailed description together with the accompanying drawings, in which:

FIG. 1 is a cross-sectional view of a supercapacitor device fabricated in accordance with the present invention.

FIG. 2 is a sketched plot of a substantially bimodal pore size distribution for the carbon electrode material described in Example 11.

### DETAILED DESCRIPTION

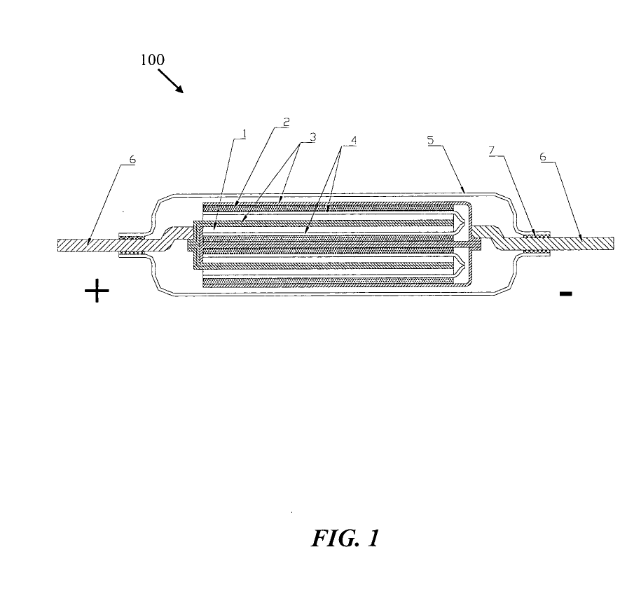

The invention will be described in more detail with reference to exemplifying embodiments thereof and also with reference to the accompanying drawings. FIG. 1 is a cross-sectional view of an electrochemical double layer capacitor (EDLC) 100 having a plurality of anodes and cathodes connected in parallel in accordance with the present invention. EDLC 100 includes a hermetic case 5, enclosed by sealing 7. Inside of the case 5 is situated one or more electrode pairs, such as nanoporous anode 1 and nanoporous cathode 2. The nanoporous electrodes 1 and 2 are separated by a porous separator 4. Preferably, the nanoporous electrodes 1 and 2, as well as porous separator 4 are saturated with an organic electrolyte. To the electrodes 1 and 2 are attached metal current collectors 3 which are in turn joined to a terminal lead 6.

The invention provides in one aspect a method for forming nanoporous carbon powder manufactured with closely controlled pore size and low ash content. Such powder can be processed to fabricate low cost and high performance electrodes in such a manner that the resultant electrode has pore sizes which are selectively and closely controlled. Thin electrodes can be made using carbon powder according to the invention.

A method of forming nanoporous electrodes includes the steps of providing a natural carbonaceous material, the carbonaceous material having pores filled with at least one generally inorganic material, such as calcium phosphate in the case of bone flour or bone char coal. The carbonaceous material is treated with a strong acid and/or a strong base, where the generally inorganic material is removed from the pores to form open pores and to increase their size. The open pores of the powder are then impregnated with an organic electrolyte to form a composite electrode, such as for use in EDLCs. Although generally described with respect to EDLCs, the invention can be used to form other energy storage devices, including electrodes for high power lithium-based batteries.

When the initial carbonaceous material is bituminous-based activated carbon, a strong base such as an alkali hydroxide, including NaOH or KOH can be used. In this embodiment, the treating step can be performed at a temperature of between 90 and 900° C., such as 700° C. Time and temperature can be used to vary the average size of the pores, with longer times and higher temperatures generally leading to increasing pore size. The resulting average pore size using this embodiment is generally about 1-3 nm.

When the natural carbonaceous material is bone flour or bone char, a strong acid, such as phosphoric acid can also be used. In this embodiment the treating step can be performed at a temperature of between 0 and 100° C., including room temperature. This embodiment generally produces a substantially single mode pore size distribution from about 4 to 20 nm.

Electrodes are preferably formed from nanoporous powder according to the invention by impregnating the open pores with an organic electrolyte to form a composite electrode. Preferred electrolytes are based on tetrakis(dialkylamino)phosphonium or tetraalkylammonium tetrafluoroborates or hexafluorophosphates or their mixtures dissolved in a polar aprotic solvent or in the mixture of such solvents selected from nitrites (acetonitrile, propionitrile, 3-methoxy propionitrile), lactones (γ-butyrolactone, γ-valerolactone), carbonates (propylene carbonate, ethylene carbonate, ethyl methyl carbonate), N,N-dimethylformamide, 1-methyl-2-pyrrolidinone, methyl ethyl ketone, dimethoxyethane or tetrahydrofurane.

In one embodiment of the invention, a pore size of the nanoporous cathode is larger than a pore size of the nanoporous anode. Since cations are generally larger in size as compared to anions, such an arrangement has been found to further improve the performance of EDLCs according to the invention. The bituminous-based activated carbon strong base process can be used to obtain a larger pore size for the cathode as compared to the anode from a given precursor through variations in time and temperature of processing.

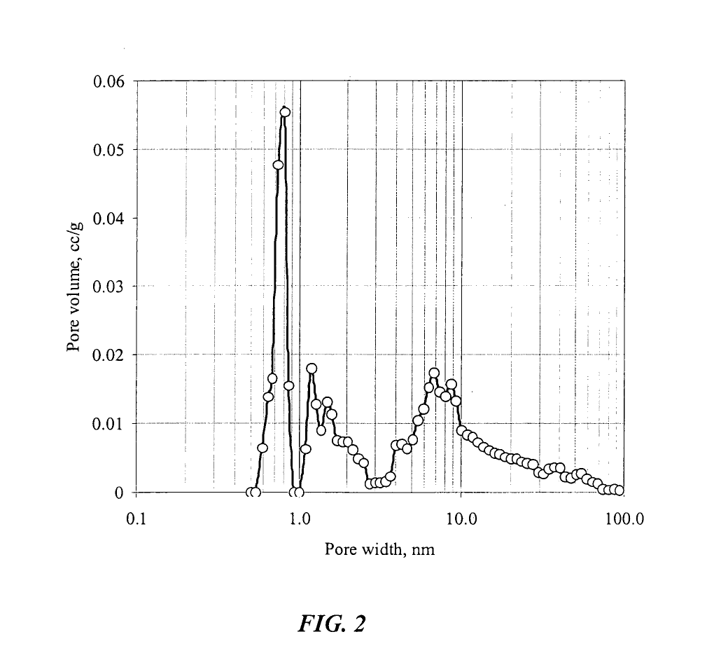

Electrodes for both the anode and cathode can also be formed by combining nanoporous carbon obtained from each of the above-described method embodiments. This embodiment has been found to generally provide a substantially bimodal pore size distribution having primary distribution centered at about 0.6 to 3 nm and a second distribution centered at about 5 to 12 nm, the second distribution preferably having an amplitude of at least 20% (such as 30% or 40%) of an amplitude of the first distribution. FIG. 2 shows a depiction of a substantially bimodal pore size distribution. The large peak centered at about 0.8 nm can be considered to include the adjacent peak centered at a little over 1 nm. The presence of a significant percentage of large (wide) pores in the overall pore distribution has been found to provide an enhanced power output for EDLCs according to the invention.

An exemplary general route for manufacturing high performance EDLCs according to the invention is described below. A mixture of nanoporous carbon powder(s) formed using the invention as described above, such as by alkaline etching a bituminous-based activated carbon powder or acid etching a bone char powder, together with a binder (e.g., PTFE powder) is kneaded with a plasticizer (e.g., ethanol) followed by rolling thin flat electrodes. The mixture can also include an electrically conductive additive such as, carbon black or thermo expanded graphite. The mixture can also include a gel-forming agent such as, AEROSIL-200® or AEROSIL-300®, produced by Degussa. AEROSIL® fumed silica is a highly dispersed silicon dioxide, being a fine, amorphous white powder of very high purity. The extremely small primary particles result in a large specific surface area, ranging from about 50 to 380 m²/g.

To match the total surface area of cathode and anode with the size of the respective ions in the electrolyte, the cathodes and anodes of different porosity and/or different thickness are preferably manufactured, the thickness generally being within the range of 40-200 μm. PTFE powder or its suspension in water can be used as a binder, its content in the composite electrodes being between about 2 and 12% wt. A layer of aluminum is deposited on the electrode surface using plasma, magnetron or electron-beam sputtering, the layer being about 0.5 to 5 μm thick. An electrically insulating layer (separator) is preferably manufactured of nano-size dielectric particles (e.g., AEROSIL-200® or AEROSIL-300®) with a binder (e.g., PTFE powder) and is rolled directly on the electrode surface. The device is then assembled, wherein a pack of electrodes interposed with the separator is placed into a light flexible shell, such as A1 foil laminated with PE or PP. An organic electrolyte is then introduced into the device to impregnate the electrodes and the separator, or a slight excess over the level to impregnate.

These preferred electrolytes provided above are generally stable both chemically and electrochemically, and they maintain their performance in a wide temperature range. In order to avoid the electrolyte depletion between the electrodes when EDLC is charged up to the rate voltage as well as to reduce the internal resistance of the EDLC, the total salt concentration in the electrolyte is preferably chosen in the range of 1-3 mol/l.

Since the separator porosity and thickness affect significantly the equivalent series resistance of EDLC device, in a preferred embodiment of the present invention, the separator is 5-30 μm thick with a porosity of 60 to 80%, such as about 70%. As noted above, the separator is preferably manufactured of nano-size dielectric particles (e.g., AEROSIL-200® or AEROSIL-300® particles), which are kneaded with a binder and then rolled directly on the electrode surface.

### EXAMPLES

The present invention is described in more detail below through Examples. It should be understood, however, that the present invention is not limited to these Examples but can as well be embodied in other forms and devices without departing from the scope and spirit of the invention.

### Example 1

5 grams of commercially available bituminous coal-based activated carbon powder (trade name of FILTRASORB-300®; produced by Chemviron Carbon, which is the European operation of American Calgon Carbon Corporation, ash content of 6.5% wt.) was mixed with 20 grams of potassium hydroxide (KOH), and the mixture was heated in an argon stream at a temperature elevation rate of 10° C. per minute from room temperature to 760° C. and then treated at this temperature for an hour. FILTRASORB® carbons are based on natural bituminous coal. After cooling, the mixture was washed with iso-propanol, diluted acid and hot water to remove the alkali and dried. 3.3 grams of nanoporous powder with ash content of 1.9% wt. were thus obtained, and characteristics of electrodes made therefrom are described in Example 6 below and given in Table 1 below.

### Example 2

5 grams of commercially available bituminous coal-based activated carbon powder (trade name of FILTRASORB-300) were mixed with 10 grams of potassium hydroxide (KOH), and the mixture was heated in an argon stream at a temperature elevation rate of 10° C. per minute from room temperature to 760° C. and then treated at this temperature for an hour. After cooling, the mixture was washed with iso-propanol, diluted acid and hot water to remove the alkali and dried. 3.5 grams of nanoporous powder with ash content of 1.8% wt. were thus obtained, and characteristics of electrodes made therefrom are described in Example 7 below and are given in Table 1 below.

### Example 3

5 grams of commercially available bituminous coal-based activated carbon powder (trade name of FILTRASORB-400, ash content of 5.5% wt.) were mixed with 5 grams of sodium hydroxide (NaOH) dissolved in water, and the mixture was treated at the temperature of about 100° C. for two hours. After cooling, the mixture was washed with diluted acid and hot water to remove the alkali and dried. 4.5 grams of nanoporous powder with ash content of 1.6% wt. were thus obtained, and characteristics of electrodes made therefrom are described in Example 8 below and are given in Table 1 below.

### Example 4

5 grams of commercially available activated carbon powder (trade name of BL; produced by Calgon Carbon Corporation; ash content of 7.42% wt.) were mixed with 5 grams of potassium hydroxide (KOH) dissolved in water, and the mixture was treated at the temperature of about 100° C. for two hours. After cooling, the mixture was washed with diluted acid and hot water to remove the alkali and dried. 4.6 grams of nanoporous powder with ash content of 1.35% wt. were thus obtained, and characteristics of electrodes made therefrom are described in Example 9 below and are given in Table 1 below.

### Example 5

20 grams of bone flour were heated in an argon stream at a temperature elevation rate of 10° C. per minute from room temperature to 800° C. and then treated at this temperature for about 1 hour until no more gaseous decomposition products were detected using a U-shaped tube filled with water. After cooling, the resulting bone char was crushed and treated with diluted phosphoric acid to remove the calcium phosphate from the pores of the char. The carbon powder thus obtained was filtered out, washed with water and dried. 2.5 grams of nanoporous powder were obtained, and characteristics of electrodes made therefrom are described in Example 10 below and is given in Table 1 below.

### Example 6

1.5 grams of nanoporous carbon powder obtained as described in Example 1 was kneaded with 0.125 g of PTFE suspension in water (60% wt) and a small amount of ethanol, dried and rolled. The electrode sheets of 125 μm thick were rolled to be used as anodes and cathodes. One side of each electrode sheet was covered with a sheet of porous insulating material, which was prepared of AEROSIL-200 mixed with PTFE binder, the two sheets being then rolled together. The separator thickness thus obtained was about 20 μm. Electrode sheets thus made were sputtered with aluminum using the magnetron technique. Working electrodes of 7.4 mm in diameter were made of those electrode sheets, and their performance was measured in a glove box in a three-electrode cell using a mixture of 0.6 M tetrakis(dimethylamino)phosphonium tetrafluoroborate and 0.6 M triethylmethylammonium tetrafluoroborate in acetonitrile as the electrolyte. Characteristics of both positive and negative electrodes are presented in Table 1 below, line 1.

### Example 7

1.5 grams of nanoporous carbon powder obtained as described in Example 2 was kneaded with 0.125 g of PTFE suspension in water (60% wt) and a small amount of ethanol, dried and rolled. Electrode sheets of 110 μm thick were rolled to be used as anodes and cathodes. One side of an electrode sheet was covered with a sheet of porous insulating material, which was prepared of AEROSIL-200 mixed with PTFE binder. The separator thickness thus obtained was about 15 μm. Electrode sheets thus made were sputtered with aluminum using the magnetron technique. Working electrodes of 7.4 mm in diameter were made of those electrode sheets, and their performance was measured in a glove box in a three-electrode cell using a mixture of 0.6 M tetrakis(dimethylamino)phosphonium tetrafluoroborate and 0.6 M triethylmethylammonium tetrafluoroborate in acetonitrile as the electrolyte. Characteristics of both positive and negative electrodes are presented in Table 1 below, line 2.

### Example 8

1.3 grams of nanoporous carbon powder obtained as described in Example 3 was kneaded with 0.07 g of AEROSIL-300, 0.11 g of PTFE suspension in water (60% wt), 0.04 g of thermo expanded graphite and a small amount of ethanol, dried and rolled. The electrode sheets of 100 μm thick were rolled to be used as anodes and cathodes. One side of electrode sheet was covered with a sheet of porous insulating material, which was prepared of AEROSIL-300 mixed with PTFE binder, the two sheets being then rolled together. The separator thickness thus obtained was about 15 μm. Electrode sheets thus made were sputtered with aluminum using the electron-beam technique. Working electrodes of 7.4 mm in diameter were made of those electrode sheets, and their performance was measured in a glove box in a three-electrode cell using a mixture of 0.6 M tetrakis(dimethylamino)phosphonium tetrafluoroborate and 0.6 M triethylmethylammonium tetrafluoroborate in acetonitrile as the electrolyte. Characteristics of both positive and negative electrodes are presented in Table 1 below, line 3.

### Example 9

1.5 grams of nanoporous carbon powder obtained as described in Example 4 were kneaded with 0.125 g of PTFE suspension in water (60% wt) and a small amount of ethanol, dried and rolled. The electrode sheets of 100 μm thick were rolled to be used as anodes and cathodes. One side of an electrode sheet was covered with a sheet of porous insulating material, which was prepared of AEROSIL-200 mixed with PTFE binder. The separator thickness thus obtained was about 15 μm. Electrode sheets thus made were sputtered with aluminum using the magnetron technique. Working electrodes of 7.4 mm in diameter were made of those electrode sheets, and their performance was measured in a glove box in a three-electrode cell using a mixture of 0.6 M tetrakis(dimethylamino)phosphonium tetrafluoroborate and 0.6 M triethylmethylammonium tetrafluoroborate in acetonitrile as the electrolyte. Characteristics of both positive and negative electrodes are presented in Table 1 below, line 4.

### Example 10

1.5 grams of nanoporous carbon powder obtained as described in Example 5 were kneaded with 0.125 g of PTFE suspension in water (60% wt) and a small amount of ethanol, dried and rolled. The electrode sheets of 110 μm thick were rolled to be used as anodes and cathodes. One side of an electrode sheet was covered with a sheet of porous insulating material, which was prepared of AEROSIL-200 mixed with PTFE binder. The separator thickness thus obtained was about 15 μm. Electrode sheets thus made were sputtered with aluminium using the magnetron technique. Working electrodes of 7.4 mm in diameter were made of those electrode sheets, and their performance was measured in a glove box in a three-electrode cell using a mixture of 0.6 M tetrakis(dimethylamino)phosphonium tetrafluoroborate and 0.6 M triethylmethylammonium tetrafluoroborate in acetonitrile as the electrolyte. Characteristics of both positive and negative electrodes are presented in Table 1 below, line 5.

### Example 11

0.75 g of nanoporous carbon powder obtained as described in Example 2 and 0.75 g of nanoporous carbon powder obtained as described in Example 5 were mixed and then kneaded with 0.13 g of PTFE suspension in water (60% wt) and a small amount of ethanol, dried and rolled. The electrode sheets of 100 μm thick were rolled to be used as anodes and cathodes. One side of electrode sheet was covered with a sheet of porous insulating material, which was prepared of AEROSIL-300 mixed with PTFE binder, the two sheets being then rolled together. The separator thickness thus obtained was about 15 μm. Electrode sheets thus made were sputtered with aluminum using the electron-beam technique. Working electrodes of 7.4 mm in diameter were made of those electrode sheets, and their performance was measured in a glove box in a three-electrode cell using a mixture of 0.6 M tetrakis(dimethylamino)phosphonium tetrafluoroborate and 0.6 M triethylmethylammonium tetrafluoroborate in acetonitrile as the electrolyte. Characteristics of both positive and negative electrodes are presented in Table 1 below, line 6.

### Example 12

An EDLC prototype was made based on the design shown in FIG. 1. The electrode sheets of 100 μm thick were manufactured as in Example 8 and used as anodes (see anode 1 in FIG. 1), and electrode sheets of 110 μm thick were manufactured as in Example 6 and used as cathodes (see cathode 2 in FIG. 1). One side of each cathode sheet was covered with a sheet of porous insulating material (see separator 4 in FIG. 1), which was prepared of AEROSIL-200 mixed with PTFE binder, the two sheets being then rolled together. The separator thickness thus obtained was about 15 μm. Electrode sheets thus made were covered with aluminum layer of about 2 microns thick using the magnetron technique. Each electrode had the dimensions of 50×30 mm, 5 positive and 5 negative electrodes being connected in parallel and packed as shown in FIG. 1. A mixture of 0.6 M tetrakis (dimethylamino)phosphonium tetrafluoroborate and 0.6 M triethylmethylammonium tetrafluoro-borate in acetonitrile was used as the electrolyte. The characteristics of the EDLC made are presented below in Table 1, line 7.

TABLE 1
Characteristics of electrodes and an EDLC device made from powder according to
the invention formed from natural nanoporous carbon precursor materials

| | | | | Capacitance | | Time |
|---|---|---|---|---|---|---|
| | Precursor material or | Density, | Porosity, | density, | Resistivity, | constant, |
| # | EDLC prototype | g/cc | % | F/cc | Ohm · cm² | s |
| 1 | FILTRASORB-300-4 | 0.56 | 82 | 39 (+) | 0.90 (+) | 0.46 (+) |
| | (Example 6) | | | 36 (−) | 0.95 (−) | 0.43 (−) |
| 2 | FILTRASORB-300-2 | 0.54 | 83 | 38 (+) | 0.76 (+) | 0.32 (+) |
| | (Example 7) | | | 34 (−) | 0.78 (−) | 0.30 (−) |
| 3 | FILTRASORB-400-50 | 0.81 | 70 | 43 (+) | 0.83 (+) | 0.37 (+) |
| | (Example 8) | | | 33 (−) | 0.88 (−) | 0.30 (−) |
| 4 | BL-50 | 0.69 | 70 | 73 (+) | 0.35 (+) | 0.28 (+) |
| | (Example 9) | | | 30 (−) | 0.73 (−) | 0.24 (−) |
| 5 | Bone flour | 0.66 | 78 | 56 (+) | 3.50 (+) | 2.16 (+) |
| | (Example 10) | | | 64 (−) | 2.53 (−) | 1.89 (−) |
| 6 | FILTRASORB-300-2 | 0.65 | 77 | 37 (+) | 0.78 (+) | 0.31 (+) |
| | and bone flour (blend) | | | 29 (−) | 0.82 (−) | 0.29 (−) |
| | (Example 11) | | | | | |
| 7 | EDLC device | | | 11.7 | 0.46 | 0.13 |
| | (Example 12) | | | | | |

(+ and − denote the positive and negative electrode, correspondingly)

The pore structure of carbon materials obtained as described in Examples 1-5 was studied using the nitrogen adsorption/desorption curves observed with ASAP 2000 unit or Gemini 2370 (both produced by Micromeritics; Norcross, Ga.), and they were found to possess a distinct nanoporosity with BET surface area of 1200 m²/g (Example 1), 1130 m²/g (Example 2), 840 m²/g (Example 3) or 845 m²/g (Example 4). Average pore diameter varied from 1.5 nm (Example 3) to 8 nm (Example 5). Such a porosity well matches the size of ions in organic electrolytes (0.5-1 nm) which likely explains why the electrodes made of these nanoporous carbon powders demonstrate very low resistance and time constant (Table 1), which implies a high power rating.

It is to be understood that while the invention has been described in conjunction with the preferred specific embodiments thereof, that the foregoing description as well as the examples which follow are intended to illustrate and not limit the scope of the invention. Other aspects, advantages and modifications within the scope of the invention will be apparent to those skilled in the art to which the invention pertains.

We claim:

1. A method of forming nanoporous carbon material, comprising the steps of:
providing a natural carbonaceous material, said carbonaceous material having pores filled with at least one other material;
treating said carbonaceous material with a strong acid or a strong base, wherein said other material is removed from said pores to form a nanoporous carbon material having open pores.

2. The method of claim 1, wherein said carbonaceous material comprises bituminous-based activated carbon, said strong base being used during said treating step.

3. The method of claim 2, wherein an average pore size of said open pores is from 0.6 to 3 nm.

4. The method of claim 1, wherein said carbonaceous material comprises bone flour or bone char, said strong acid being used during said treating step.

5. The method of claim 4, wherein an average pore size of said open pores is from 5 to 12 nm.

6. A method of forming nanoporous electrodes, comprising the steps of:
providing a natural carbonaceous material, said carbonaceous material having pores filled with at least one other material;
treating said carbonaceous material with a strong acid or a strong base, wherein said other material is removed from said pores to form a nanoporous carbon material having open pores, and
impregnating said open pores with an organic electrolyte to form a composite electrode.

7. The method of claim 6, wherein a size distribution of said open pores includes a primary distribution and a secondary distribution.

8. The method of claim 7, wherein said primary distribution is centered at about 0.6 to 3 nm and said secondary distribution is centered at about 5 to 12 nm.

9. The method of claim 8, wherein said second distribution has an amplitude of at least 20% of an amplitude of said primary distribution.

10. The method of claim 6, further comprising the steps of kneading said nanoporous carbon material with a polymer binder suspension in a solvent to form a binder comprising nanocomposite, and then drying and rolling said binder comprising nanocomposite.

11. The method of claim 10, wherein an electrically conductive carbon powder is included in said kneading step.

12. A method of forming electrochemical double layer capacitor (EDLC), comprising the steps of:
forming a composite electrode for an anode and a cathode, said forming step comprising:
providing a natural carbonaceous material, said carbonaceous material having pores filled with at least one other material;
treating said carbonaceous material with a strong acid or a strong base, wherein said other material is removed from said pores to form a nanoporous carbon material having open pores;
impregnating said open pores with an organic electrolyte to form said composite electrode;
disposing an electrically insulating layer comprising a plurality of nano-size dielectric particles together with a binder comprising slurry directly onto a surface of at least one of said composite electrodes; and
interposing said electrically insulating layer between said anode and said cathode.

13. The method of claim 12, wherein said disposing step comprises rolling.

14. The method of claim 12, wherein said impregnating step follows said interposing step, said impregnating step impregnating said electrically insulating layer in addition to said anode and cathode with said organic electrolyte.

15. The method of claim capacitor of claim 12, wherein said anode and cathode include a gel-forming agent.

16. The method of claim 12, wherein an average pore size of said cathode is larger than an average pore size of said anode.
